(19) United States
(12) Patent Application Publication
(10) Pub. No.: US 2009/0260775 A1
(43) Pub. Date: Oct. 22, 2009

(54) HEAT EXCHANGER, IN PARTICULAR AN EXHAUST GAS EVAPORATOR OF A MOTOR VEHICLE

(76) Inventors: Ulrich MAUCHER, Korntal-Muenchingen (DE); Martin Kaemmerer, Bietigheim-Bissingen (DE); Diem Johannes, Weissach (DE)

Correspondence Address: Muncy, Geissler, Olds & Lowe, PLLC, P.O. BOX 1364, FAIRFAX, VA, 22038-1364, US

(21) Appl. No.: 12/421,394

(22) Filed: Apr. 9, 2009

(30) Foreign Application Priority Data
Apr. 16, 2008 (DE) DE 102008019320.8
Oct. 6, 2008 (DE) DE 102008050120.4

(51) Int. Cl. B60H 1/00; F28D 7/00; F28F 3/00

(52) U.S. Cl. 165/41; 165/162; 165/166

(57) ABSTRACT

A heat exchanger is provided, in particular an exhaust gas evaporator of a motor vehicle, including a heat exchanger block, a first axial terminating device and a second axial terminating device, in which the heat exchanger block has axial inlet openings and axial outlet openings, and in which means for forming a positive fit with the axial terminating devices are situated on the heat exchanger block, the means for forming the positive fit projecting at least partially over the axial inlet openings and/or over the axial outlet openings in the heat exchanger block in the axial direction, such that they may be situated radially next to contact shoulders of the axial terminating devices, thereby providing a heat exchanger that is particularly pressure-resistant in the radial direction.

This nonprovisional application claims priority under 35 U.S.C. § 119(a) to German Patent Application Nos. DE 10 2008 019 320.8, which was filed in Germany on Apr. 16, 2008, and to DE 10 2008 050 120.4, which was filed in Germany on Oct. 6, 2008 and which are both herein incorporated by reference.

### BACKGROUND OF THE INVENTION

1. Field of the Invention

The invention relates to a heat exchanger, in particular, an exhaust gas evaporator of a motor vehicle, comprising a heat exchanger block, a first axial terminating device and a second axial terminating device, in which the heat exchanger block has both axial inlet openings and axial outlet openings.

2. Description of the Background Art

Heat exchangers are known from the prior art, at least to the extent that they may be used to cool exhaust gases of internal combustion engines of motor vehicles. In this connection, for example, a heat exchanger is described in German patent application DE 10 2006 043 951 A1, which corresponds to U.S. Publication No. US20080277105, and which may be joined as a simple soldered construction in just one operation. For this purpose, the heat exchanger has a plurality of pipes of a flat design, through which the exhaust gases are conducted. A coolant may be made to flow around the flat pipes for the purpose of cooling the exhaust gases flowing through them. To be able to position the flat pipes in relation to each other, all ends of the flat pipes are inserted into pipe bases that are provided with correspondingly designed passages. The ends of the pipes may then be advantageously soldered to the pipe bases, and other heat exchanger components may be advantageously soldered to each other, in a single soldering operation, making it possible to manufacture the heat exchange cost-effectively.

In addition to heat exchangers, by means of which exhaust gases of an internal combustion engine are to be cooled, heat exchangers are more and more often required in the form of exhaust gas evaporators, which include both a hot exhaust gas side and a cooling evaporator side, by means of which the thermal energy from the exhaust gases may be suitably converted, for example using a Rankine process, and subsequently used as mechanical energy. Compared to conventional heat exchangers for cooling exhaust gases, greater mechanical stresses, in particular, occur on exhaust gas evaporators of this type, due to much higher operating pressures.

A fuel evaporator of a fuel cell system is known from the publication DE 602 16 875 T2, which corresponds to U.S. Publications Nos. 20050287409 and 2003077490, and which has an evaporator core at whose axial ends conically tapered heads are situated. Hot gases are supplied to the core via these heads, on the one hand, and removed again after passing through the core, on the other hand. The evaporator core has a layered structure made of separator plates, fins and spacer bars as well as solder foils for soldering the individual core components. To simplify the assembly of the individual components, the core components to be soldered to each other are held together by brackets. After the evaporator core components are soldered by a soldering process, the brackets are mechanically removed. The heads are then axially mounted on the evaporator core thus manufactured and welded to the evaporator core of the fuel evaporator. This two-step manufacturing process, involving a soldering process and a subsequent welding process, is extremely complex and therefore also costly.

A fuel evaporator is known from U.S. Pat. No. 6,953,009 B2, which essentially also has a layered structure. This fuel evaporator is used in a nearly identical fuel cell system, although the fuel evaporator shown here has a slightly modified structure, since feed devices for hot gases are not situated axially on the evaporator core, but rather radially. The individual layers are soldered together in this case as well, and they must be held together by a soldering frame in order to remain in their specified position during a soldering process.

### SUMMARY OF THE INVENTION

It is therefore an object of the present invention is to provide a heat exchanger, so that, on the one hand, elevated stresses may be withstood over the long term and, on the other hand, a heat exchanger may be reliably manufactured with a high degree of dimensional accuracy in a simple production process.

The object of the invention is achieved in an example embodiment by a heat exchanger, in particular an exhaust gas evaporator of a motor vehicle, including a heat exchanger block, a first axial terminating device and a second axial terminating device, in which the heat exchanger block has both axial inlet openings and axial outlet openings, and in which means for forming a positive fit with the axial terminating devices are situated on the heat exchanger block, the means for forming the positive fit projecting at least partially over the axial inlet openings and/or over the axial outlet openings in the heat exchanger block in the axial direction, such that they may be situated radially next to contact shoulders of the axial terminating devices.

Means for forming the positive fit, hereinafter referred to in short as positive fit means, may advantageously be used hereby to design a particularly stable heat exchanger, in particular the heat exchanger block of the heat exchanger, using a particularly simple structural design, without having to take substantial weight disadvantages into account due to a more massive design. By these means, the present heat exchanger may withstand even particularly high operating pressures exceeding 50 bar, so that the heat exchanger is also particularly suitable for use as an exhaust gas evaporator. The present heat exchanger may continuously withstand even high pressure differences, for example between an exhaust gas side of the heat exchanger at approximately 5 bar and a evaporator side of the heat exchanger at, for example, 30 bar, due to the provided positive fit means.

For example, with the aid of a suitable coolant that is evaporated or superheated on the evaporator side of the heat exchanger by means of the thermal energy of the exhaust gases present on the exhaust gas side, mechanical energy may be obtained in an expansion engine, for example in a piston engine or a turbine. The mechanical energy may be supplied directly to a drivetrain of a motor vehicle or used to drive auxiliary units, for example, to drive a generator for obtaining electrical energy.

In any case, the heat exchanger according to the invention advantageously has a high fatigue strength, despite a relatively low weight, due to the fact that the heat exchanger block is additionally positively connected to the terminating devices of the heat exchanger via the positive fit means.

However, a particular advantage in this case is the fact that by means of the structure of the heat exchanger according to an embodiment of the invention, it is possible by way of a simple design to provide a particularly simple and operationally reliable soldering process having extraordinarily good soldering results. This is due in part to the fact that it is almost impossible for stacked heat exchanger components to move outward to a critical degree, particularly in the stacking direction of the components, as a result of the contact shoulder. This makes it possible to maintain narrow gaps between the individual components, so that very good solder joints may be achieved between the components. This also eliminates the need for additional positioning of the components, in particular tack welders or soldering frames, which would otherwise be customary, in order to fix the components in place for the soldering process.

The term “positive fit means” or “positive fit component” may cover all structures that extend far enough over an edge of the heat exchanger block in order to be able to positively communicate with suitably designed radial contact shoulders and/or grooves in the particular terminating device of the heat exchanger.

The term “contact shoulder” generally describes any device of an axial terminating device on which a component of the heat exchanger block may be radially supported, so that these components are unable to move laterally to a critical degree from a preset position.

The term “heat exchanger” generally describes any device by means of which process heat may be transferred from a first medium to a further medium, so that the first medium may be cooled thereby. In particular, heat exchangers of motor vehicles are covered in the form of exhaust gas evaporators that are operable in an exhaust gas system. The heat exchanger in this case preferably has an exhaust gas side and a evaporator side.

The term “exhaust gas system” is generally understood to be any component through which exhaust gases of an internal combustion engine are conducted after leaving the internal combustion engine. The term “exhaust gas system” thus also covers components of an exhaust gas recirculation system. In particular, the exhaust gas evaporator described herein may be advantageously integrated into an exhaust gas recirculation system of this type.

The term “heat exchanger block” generally describes a component of the present heat exchanger. The heat exchanger block in this case can include the heat exchanger components that make it possible to transfer heat from a first medium, such as exhaust gases, to a second medium, such as an vaporizable coolant. For this purpose, the heat exchanger block has at least exhaust gas channels and coolant channels, which can be situated side-by-side in an alternating arrangement. According to an example embodiment, the heat exchanger block can be manufactured in a sandwich design. The term “sandwich design” is largely self-explanatory, it being clear, particularly in connection with the exhaust gas evaporator described herein, that exhaust gas layers are situated such that they alternate with coolant layers in or on the exhaust gas evaporator. The designation “plate design” can be used for the term “sandwich design” herein.

The term “axial terminating device” is generally understood to be any device that may be situated at axial ends of a heat exchanger block in order, on the one hand, to stabilize the heat exchanger block and in particular to strengthen it against radially acting compressive forces and, on the other hand, to give the heat exchanger as a whole a stable and secure termination, so that it may be integrated without problems into an exhaust gas system.

The axial inlet openings and axial outlet openings in this connection describe openings in a heat exchanger block through which exhaust gases of an internal combustion engine may enter the exhaust gas layers of the heat exchanger block at a first axial end of the heat exchanger block and emerge from the exhaust gas layers at a further axial end of the heat exchanger block.

The means explained above for forming the positive fit of the heat exchanger block may be provided through a particularly simple structural design if the means for forming the positive fit are formed from radially external components of the heat exchanger block.

As explained above, the heat exchanger block can be manufactured in a sandwich design. The heat exchanger may be constructed in a simple design in layers, using individual components such as laminated plates, exhaust gas channel layers and lateral spacer bars for positioning the laminated plates and exhaust gas channel layers at a distance from each other, by suitably cassetting the individual components together and subsequently soldering them, preferably together with axial terminating devices. An exemplary embodiment to be explained later on shows an advantageous structure thereof.

The means for forming the positive fit may be very securely mounted radially if the means for forming the positive fit may be situated in axially open grooves in the axial terminating devices.

If the present positive fit means of the heat exchanger block are formed, in particular, by radially external components such as external laminated plates or terminating plates of the heat exchanger block, or by external spacer bars, the positive fit means may be advantageously provided by existing heat exchanger block components. This makes it possible to give the entire heat exchanger a light-weight construction, and it will also have a particularly high strength. Particularly with regard to alternating thermal loads and cyclical compressive loads on an exhaust gas evaporator, particularly high and good strength properties are particularly advantageous.

In connection with a highly compact embodiment variant, it is advantageous if the radially external components of the heat exchanger block form a casing of the heat exchanger block.

It is thus also particularly advantageous if the means for forming the positive fit are formed by spacer bars and/or laminated plates of the heat exchanger block.

It is understood that the laminated plates, spacer bars or other components of a heat exchanger block may be designed in a different shape at the axial ends of the heat exchanger block. In particular, if the spacer bars of the heat exchanger block are bent radially to the outside or radially to the inside at their axial ends, positive fit means of the heat exchanger block may be given a particularly simple design.

The present positive fit means are particularly suitable for preventing radial dislocation of components of a heat exchanger block, whether this be due to very high operating pressures or due to extreme heating of the heat exchanger block components during a soldering operation. In each case, the heat exchanger block components may be provided with particularly effective radial support by the positive fit means.

In particular, in order to prevent such radial dislocation of components in the stacking direction of the heat exchanger block, it is advantageous if an outer component of the heat exchanger block is able to be supported radially on a correspondingly placed contact shoulder.

In this connection, it is advantageous if the axially open grooves of the axial terminating devices have an outer groove shoulder and/or an inner groove shoulder on which the means for forming the positive fit may be radially supported.

If, in addition to this, a radial contact shoulder or an inner groove shoulder of the axially open grooves forms an axial limit stop for heat exchanger block components, in particular for laminated plates, spacer bars and/or connecting channels of the heat exchanger block, components of the heat exchanger block may also be axially fixed through simple structural components.

To fix at least individual heat exchanger block components particularly securely in the axial direction, it is additionally advantageous if the heat exchanger block has axially acting fixing means that project radially over the heat exchanger block, in particular radially over the casing of the heat exchanger block. The axial fixing means may be provided cumulatively or alternatively to the positive fit means explained above. The axial fixing means are particularly advantageous with regard to heat exchanger block components that have not yet been soldered together, since the axially acting fixing means may help reduce the danger of heat exchanger block components moving toward each other in the axial direction, in particular before or during the soldering of a heat exchanger.

Like the positive fit means, it is also advantageous with regard to the axially acting fixing means if the axially acting fixing means are situated on the laminated plates and/or on the spacer bars. This makes it possible to provide the axially acting fixing means via existing heat exchanger bock components, using a simple structural design.

In order for the axially acting fixing means to advantageously interact with the axial terminating devices of the heat exchanger, it is advantageous if the axial terminating devices have radially open fixing grooves for the axially acting fixing means of the heat exchanger block.

If the radially open fixing grooves are situated upstream from the axially open grooves in the axial direction, the radially open fixing grooves may be machined onto the axial terminating devices without problems.

If an axially open groove of the axial terminating devices and/or a radially open fixing groove of the axial terminating devices has a solder depot, a common soldering operation on the heat exchanger may be carried out particularly easily, since solder may be advantageously provided to the soldering areas by a solder depot of this type.

According to a further embodiment, the axial terminating devices can have a connecting flange for an exhaust gas system of a motor vehicle. A connecting flange of this type makes it possible to install a heat exchanger, in particular an exhaust gas evaporator, into an exhaust gas system. In particular, an axial terminating device may also directly include a diffuser of an exhaust gas system.

With regard to a specific example, an exhaust gas evaporator may be provided with a frame design. In this case, largely flat separator plates also act as partition walls between channels for two media (exhaust gases and coolant), the channels being sealed to the outside against the environment by frames, preferably by largely rectangular bars. Exhaust gas channels of the exhaust gas evaporator are not sealed in the longitudinal direction, making it possible for exhaust gases to flow through the exhaust gas evaporator in the axial direction. Coolant channels, on the other hand, are sealed in the longitudinal direction by a preferably largely rectangular bar, so that exhaust gases are unable to enter the coolant channels. The coolant channels communicate with each other via tubular connecting channels that are passed through the exhaust gas channels. The exhaust gas evaporator is preferably provided with fins on both sides, the fins being clearly separated on the exhaust gas side and on the coolant side. On the exhaust gas side, customary exhaust gas cooling fins may be used, for example fins of a corrugated design, or web fins having straight or inclined teeth. A key point here is that an axial termination of the exhaust gas evaporator, i.e., the exhaust gas inlet and exhaust gas outlet, is soldered to a heat exchanger block as a flange or diffuser in a circumferential solder joint, for example the flange being able to surround the block on the outside, and the solder joint running circumferentially on the outside of the block. Alternatively, however, the flange may be inserted internally. The flange or diffuser is preferably placed over the cassetted block in the axial direction and advantageously fixes the block during the soldering process. To ensure a narrow gap, the bars in this case should ordinarily be fixed toward the inside to prevent slippage, e.g., by preassembling each one with a separating plate to form a module. Compression of the assembly during the soldering process typically results in substantial shrinkage in the stacking direction for the purpose of fixing a narrow joint during the soldering process. This shrinkage is even greater, in particular, if soldering pastes are used, in which the solder layer thickness is substantially reduced by degassing the binder during the soldering process. In this case, the flange must be inserted and the circumferential joint runs on the inside of the “block wall” made of separator plates and bars. The separator plates are then lengthened on the sides in the axial direction, and the outer bars also protect axially over the media channels, thereby producing two closed outer walls. These are preferably inserted into a groove running in the stacking direction in the diffuser or flange of the exhaust gas evaporator. This makes it possible to precisely position the bars and separator plates at right angles to the stacking direction, and a narrow, effectively solderable gap between the two lateral sides of the grooves and the bars and separator plates is produced at right angles to the stacking direction. The bottom separator plate in the stacking direction (separating the bottom channel to the outside) is placed on a shoulder of the flange or diffuser in the stacking direction. The flange or diffuser has a further upper shoulder onto which the top separator plate is placed in the stacking direction (separating the top channel to the outside). During cassetting of the exhaust gas evaporator, a gap may first be produced between the top separator plate and, for example, the flange, this gap being closed by shrinkage during the soldering process. A closed, circumferential, lateral gap, which produces a tight and mechanically sturdy solder joint between the block and flange or diffuser, is created. In a variant thereof, separator plates may have lateral projections (barbs) to the outside and/or lateral projections to the inside, which engage with a corresponding lateral groove of the flange, for example, which runs in the stacking direction, and enable axial fixing of the separator plates and the flange or diffuser. The separator plates and frames are pushed into the flange in the stacking direction, resulting in a positive fit. Particularly during the soldering process, this prevents the flange from tilting axially, for example, and there is no need for further fixing of the flange, for example using a soldering frame. Bars and separator plates are also positioned axially and fixed laterally, and there is no need for preassembly for form separator plate/frame modules, for example using tack welders. With regard to manufacturability, it is advantageous if the barbs come to rest in the area of the flange or diffuser, in which a separator plate projection is no longer enclosed on both sides by the groove. Alternatively or in addition thereto, barbs may also be formed on the side bars of the channels. The ends of the side bars may also be bent toward the inside or outside and thus engage with a corresponding groove in the flange in order to fix the flange axially during the soldering process. In all cases described, it is possible as a rule to not push on the flange or diffuser in the axial direction, but instead, the components are inserted radially into the flange in the stacking direction during a cassetting process. The groove may be designed to be deeper than the insertion depth of the separator plates and bars, whereby they may be simultaneously used as a solder depot. This produces a particularly simple soldering process. To prevent solder from being scraped out during cassetting, the groove may have a stepped design, particularly in the axial direction of the exhaust gas evaporator, so that a limit stop for the inserted components, and thereby a protected solder depot, are produced. Furthermore, the flange or diffuser may extend to the beginning of the channels and form an axial limit stop, for example, for a gas fin and an end bar that seals the coolant channel in the axial direction. The fin plate may also serve as a limit stop for this end bar toward the inside of the channel, so that no prefixing (for example, by tack welders) is again necessary for this end bar. The flange or diffuser may also fix a pipe segment or connecting channel in the axial direction, which is used as a passage for the coolant. Fixing in other directions may be advantageously carried out by a suitable recess in the gas fin and/or by the longitudinal bar (sealing toward the outside) of the heat exchanger. The media are preferably conducted against the current. In particular, the coolant can be conducted via a large number of turns (10 to 300) so that it meanders through the coolant channel. After installation in the vehicle, the stacking direction is then preferably approximately horizontal. Using a countercurrent architecture, the longitudinal axis of the exhaust gas evaporator is preferably arranged horizontally or ascending with regard to coolant conduction. If the longitudinal axis of the exhaust gas evaporator rises steeply with regard to coolant conduction (>approximately 15° to 45° in a narrow, elongated design, or 45° to 70° in a compact design), the orientation of the stacking direction of the exhaust gas evaporator in the installed state is usually secondary and may largely be freely selected. The design explained above is particularly suitable for exhaust gas evaporators, but may also be suitable for other high-load heat exchanger applications, in particular for gas/liquid heat exchangers such as exhaust gas coolers, charge air coolers and the like.

Further advantages, goals and characteristics of the present invention are explained on the basis of the following description of the attached drawing, in which an exhaust gas evaporator is illustrated by way of example, including its components and including positive fit means of alternative designs. Components that perform at least largely identical functions in the figures may be identified by the same reference numeral, these components not requiring referencing or explanation in all figures.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of an exhaust gas system of an internal combustion engine of a commercial vehicle, in which an exhaust gas evaporator or multiple exhaust gas evaporators may be integrated;

FIG. 2 shows a schematic exploded view of components of a heat exchanger block of an exhaust gas evaporator;

FIG. 3A shows a schematic perspective view of a cassetted heat exchanger block;

FIG. 3 shows a schematic perspective view of the cassetted heat exchanger block from FIG. 3A, having a mounted flange;

FIG. 4 shows a schematic perspective view of the flange from FIG. 3;

FIG. 5 shows a schematic longitudinal cross-section of an exhaust gas evaporator at the height of a laminated plate of the heat exchanger block, including a positive fit component and a mounted diffuser;

FIG. 6 shows a further schematic longitudinal cross-section of the exhaust gas evaporator from FIG. 5 at the height of an exhaust gas layer of the heat exchanger block, including a mounted diffuser;

FIG. 7 shows a schematic view of an alternative connection between a laminated plate of a heat exchanger block, inserted into a diffuser, including the positive fit component and an axially acting fixing component;

FIG. 8 shows a schematic view of axially acting fixing component of an alternative design;

FIG. 9 shows a schematic view of an axially open groove having a solder depot on an axial closing device of an exhaust gas evaporator;

FIG. 10 shows a partial schematic view of a frame made of spacer bars of a heat exchanger block;

FIG. 11 shows a schematic view of a further connection between an axial spacer bar and a radial spacer bar of a frame of a heat exchanger block;

FIG. 12 shows a schematic view of an alternative connection between an axial spacer bar and a radial spacer bar of a frame of a heat exchanger block; and

FIG. 13 shows a schematic view of a further alternative connection between an axial spacer bar and a radial spacer bar of a frame of a heat exchanger block.

### DETAILED DESCRIPTION

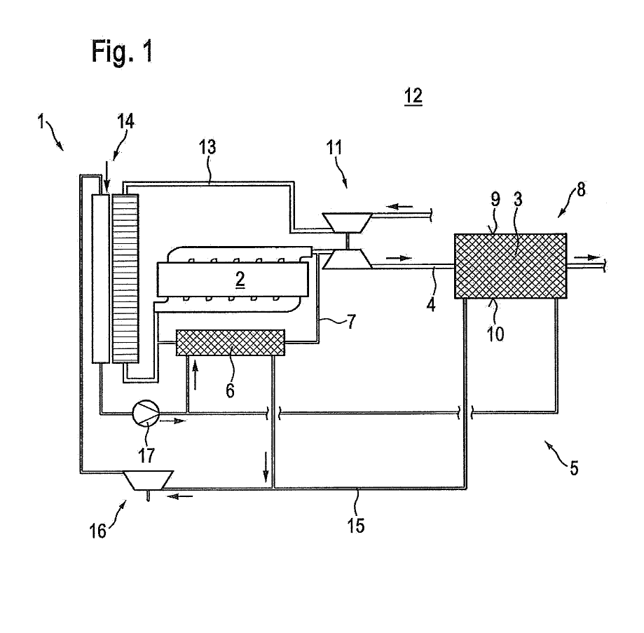

In circuit 1, shown by way of example in FIG. 1, of an internal combustion engine 2 of a vehicle, which is not illustrated here, either an exhaust gas evaporator 3 may be integrated into a main exhaust gas line 4 of an exhaust gas system 5 and/or an exhaust gas evaporator 6 may be integrated into an exhaust gas recirculation line 7 of the exhaust gas system 5. Each of exhaust gas evaporators 3 and 6 is a heat exchanger 8 (which is identified here only by way of example with regard to exhaust gas evaporator 3), which has a hot exhaust gas side 9 and a cooler evaporator side 10.

A turbine 11, which is driven by the exhaust gases (not illustrated here), is situated upstream from exhaust gas evaporator 3 in the main exhaust gas line 4. Ambient air 12 is additionally supplied to internal combustion engine 2 by turbine 11 via an air supply line 13. A condenser 14, whose function is discussed further below, is situated in air supply line 13. Exhaust gas recirculation line 7 also empties into air supply line 13 shortly before internal combustion engine 2.

Using the exhaust gases of internal combustion engine 2, a coolant that is able to flow within a coolant line 15 may be heated or evaporated at one of the two exhaust gas evaporators 3, 6, or at both exhaust gas evaporators 3 and 6, on relevant evaporator side 10, so that the coolant (not illustrated here) may perform mechanical work on an expansion engine 16 provided in coolant line 15. This makes it possible to convert thermal energy from the exhaust gases of internal combustion engine 2 to kinetic energy, particularly on expansion engine 16. For example, the kinetic energy may be converted by suitable generators (not illustrated here) to electrical energy, which may then be used in the vehicle.

After passing through expansion engine 16, which in this exemplary embodiment is a turbine, the coolant may be advantageously cooled by condenser 14 before being subsequently compressed by a compressor 17 and supplied to exhaust gas evaporator(s) 3 and/or 6.

It is noted that great pressure differences may occur between a particular exhaust gas side 9 and a corresponding evaporator side 10 of exhaust gas evaporators 3, 6. More than 50 bar of pressure may occur without problems, in particular, on evaporator side 10. These extreme pressures may have a disadvantage effect on exhaust gas evaporators 3 and 6 over the long term and, in particular, negatively impair their fatigue strength. Exhaust gas evaporators 3, 6 must therefore be constructed in a particularly sturdy design without having too heavy a construction, since they are used in motor vehicles.

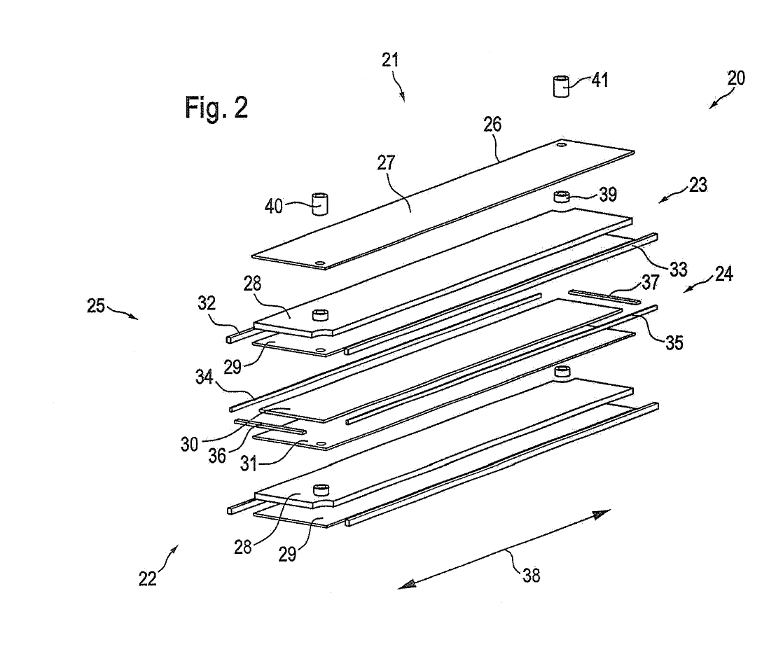

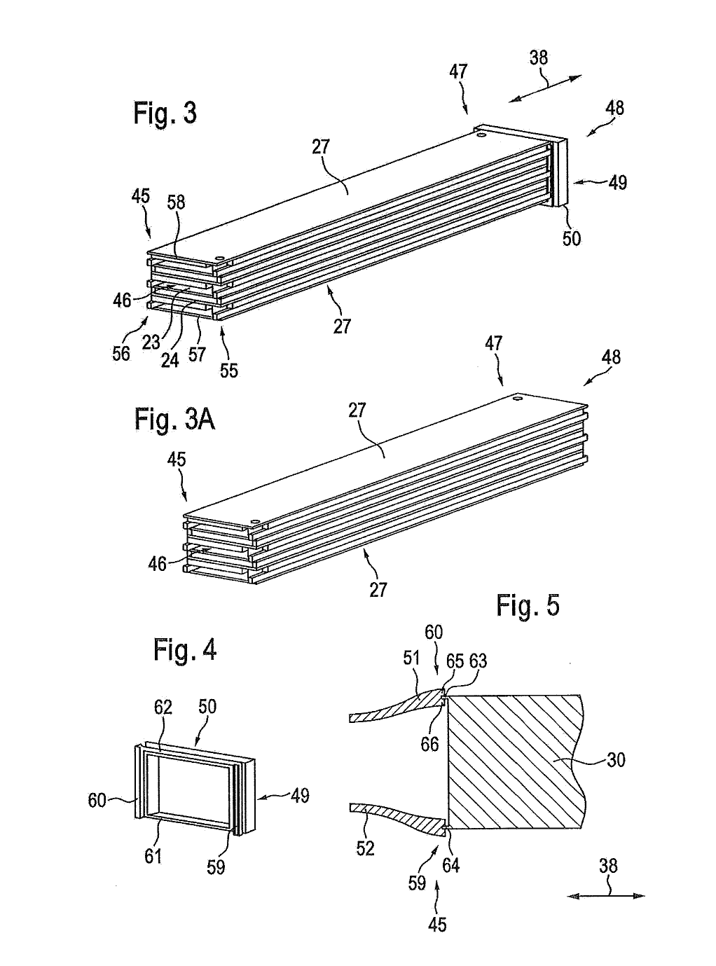

Exhaust gas side 9 and evaporator side 10 are essentially implemented by a heat exchanger block 20, as partially illustrated according to an exploded view 21 in FIG. 2. It is clear that heat exchanger block 20 is assembled in layers in a sandwich design 22, exhaust gas layers 23 and coolant layers 24 alternating with each other (see FIGS. 3A and 3, in particular). In this case, exhaust gas layers 23 form exhaust gas side 9 and coolant layers 24 form evaporator side 10 of exhaust gas evaporators 3 and 6.

According to exploded view 21 (FIG. 2), the following components 25 are provided: an outer laminated plate 27 is provided as the top and therefore an outer component 26 of heat exchanger block 20, followed by an exhaust gas channel 28 and a laminated exhaust gas plate 29, which together form an exhaust gas layer 23. Exhaust gas channel 28, in particular, has a fin structure in order to increase heat transfer. Below this is a coolant fin 30 and a laminated coolant plate 31 situated at a distance therefrom, which forms a coolant layer 24 together with a meandering coolant channel. Coolant fin 30 is used to increase a pressure stability within the meandering coolant channel. After this are provided another exhaust gas channel 28 and a laminated exhaust gas plate 29, which can also function as a lower outer laminated plate 27 of heat exchanger block 20, which form a further exhaust gas layer 23 of heat exchanger block 20.

Exhaust gas channel 28 and laminated exhaust gas plate 29 are situated some distance apart by two axial spacer bars 32 and 33.

Laminated exhaust gas plate 29 and laminated coolant plate 31 are also situated some distance apart by axial spacer bars 34 and 35 as well as additionally by radial spacer bars 36 and 37.

Axial spacer bars 32 through 35 are configured to extend axially along longitudinal extension 38 of heat exchanger block 20, while radial spacer bars 36 and 37, on the other hand, extend at, for example, substantially right angles to longitudinal extension 38.

Further exhaust gas layers 23 and further coolant layers 24 of heat exchanger block 20 may be constructed in the same manner.

Coolant layers 24 are interconnected by connecting channels 39 (identified here only by way of example), a coolant inlet 40 and a coolant outlet 41 being provided on heat exchanger block 20.

According to the illustration in FIGS. 3A and 3, components 25 of heat exchanger block 20 are at least partially cassetted, a first axial end 45 of heat exchanger block 20 has axial inlet openings 46 for exhaust gases. Axial outlet openings 48 are provided on a second axial end 47 of heat exchanger block 20.

According to FIG. 3, an axial terminating device 49, in the form of a flange 50 (see FIG. 4, in particular), is already mounted on heat exchanger block 20 at the second axial end 47.

A diffuser 52 (see FIG. 5) may be attached to the first axial end 45 of heat exchanger block 20 as an alternative axial terminating device 51 of heat exchanger block 20.

To implement an extraordinarily good positive fit between heat exchanger block 20 and axial terminating devices 49 and 51, heat exchanger block 20 has positive fit components 55, 56, 57 and 58, which may be axially inserted into axially open grooves 59, 60, 61 and 62 in terminating devices 49 and 51.

In this exemplary embodiment, horizontal positive fit components 57 and 58 of heat exchanger block 20 are formed by two outer upper and lower laminated plates 27 of heat exchanger block 20, such that the two outer upper and lower laminated plates 27 project over axial inlet openings 46 or over axial outlet openings 48.

Vertical positive fit components 55 and 56 of heat exchanger block 20 are also formed by a particularly simple structure, such that axial spacer bars 32 through 35 project over axial inlet openings 46 or over axial outlet openings 48. Moreover, axial projections 63 and 64 may be provided on remaining laminated plates 30 and 31, these projections being able to form vertical positive fit means 55 and 56, together with spacer bars 32 through 35.

Soldering of heat exchanger block 20 and axial terminating devices 49 and 51 may be carried out in a particularly operationally reliable manner on positive fit components 55 through 58 and on axially open grooves 59 through 62 of flange 50 (see FIG. 4, in particular), since positive fit components 55 through 58 are securely fixed in axially open grooves 59 through 62. This also makes it possible to provide a closed, circumferential lateral gap in an advantageous manner. The manufacture of exhaust gas evaporators 3, 6 is thereby extraordinarily safe, so that the danger of fault soldering areas, in particular due to critical relative movements of components 25, is almost entirely ruled out. This is a special characteristic of the present exhaust gas evaporators 3 and 6, along with its particularly high long-term compressive strength, compared to conventional heat exchangers. In particular, the stacked components of the heat exchanger block are unable to be critically dislocated radially to the outside in the stacking direction, since the two outer upper and lower laminated plates 27 project into grooves 61 and 62 facing each other on the top and bottom on flange 50.

Coolant fin 30 illustrated in FIG. 5 has the two axial projections 63 and 64 on first axial end 45 of heat exchanger block 20, the axial projections forming a part of positive fit components 55 and 56. These projections 63, 64 are inserted axially into axially open grooves 59 and 60 of diffuser 52, so that each of projections 63, 64 is able to rest radially against an outer groove shoulder 65 (identified only with regard to axially open groove 60) and against an inner groove shoulder 66, thereby achieving a particularly secure radial support for coolant fin 30 on diffuser 52.

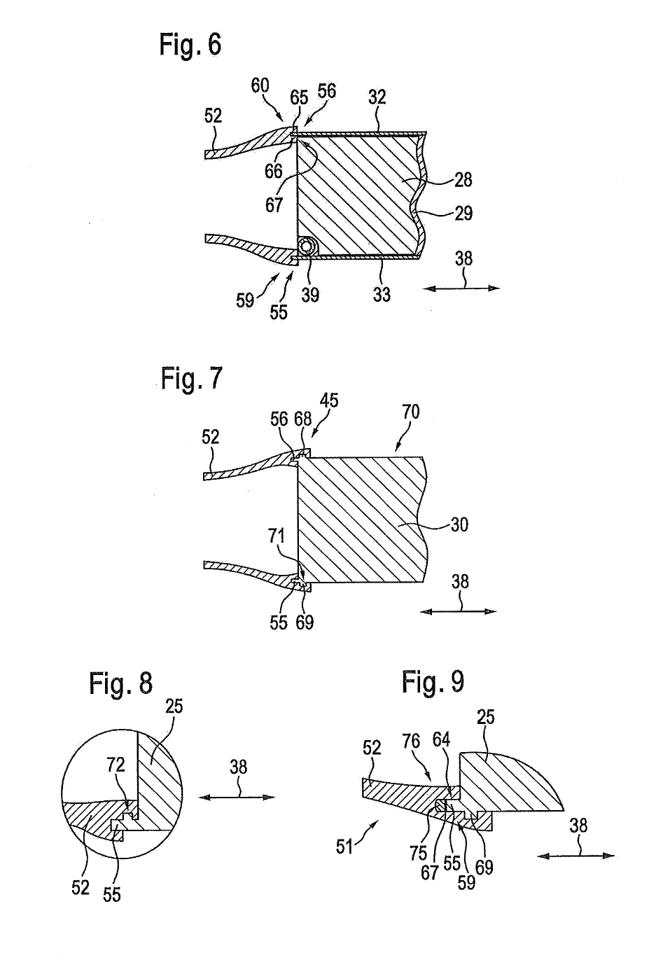

On a different layer (see FIG. 6) of heat exchanger block 20, axial spacer bars 32 and 33 are axially inserted into axially open grooves 59 and 60 of diffuser 52 in the form of positive fit components 55 and 56 of exhaust gas layer 23, thereby enabling axial spacer bars 32 and 33 to be also radially supported by outer groove shoulder 65 and inner groove shoulder 66.

Furthermore, inner groove shoulder 66 may be additionally used as an axial limit stop 67 (identified only with regard to axially open groove 60), by means of which components 25 of heat exchanger block 20 may be additionally fixed in the axial direction. This makes it possible to eliminate, in a particularly operationally reliable manner, a soldering frame or the like. According to the illustration in FIG. 6, laminated exhaust gas plate 29, and even one of connecting channels 39, may be axially fixed by inner groove shoulders 66 of exhaust gas channel 28.

Alternative coolant fin 30 illustrated in FIG. 7 has both positive fit components 55, 56 and in addition axially acting fixing components 68 and 69 at a first axial end 45. Axially acting fixing components 68, 69 project like barbs radially over a casing 70 of a heat exchanger block 20 and are thus able to engage with radially open grooves 71 (identified only with regard to axially acting fixing means 69, in the interest of clarity) of a diffuser 52, thereby fixing coolant fin 30 particularly securely to prevent slippage. Individual components 25 are inserted radially into diffuser 52, preferably at substantially right angles to longitudinal extension 38 in the stacking direction.

While axially acting fixing components 68 and 69 are oriented radially toward the outside, fixing component 72 (FIG. 8) that is oriented radially toward the inside may also be provided as an alternative on components 25 of a heat exchanger block 20.

It is understood that spacer bars 32 through 35 explained above may also have axially acting fixing components 68 and 69, by making it possible to bend ends of the spacer bars 32 through 35.

It is particularly advantageous if a solder depot 75 is provided in a groove 59, 60, 61, 62 or 71 of an axial terminating device 49, 51, such as a diffuser 52, for example with regard to the illustration according to FIG. 9. Solder depot 75 may be used to supply solder to a soldering area 76, thereby making it possible to further reduce the danger of a faulty soldering area. Solder depot 75 can be designed as an additional indentation on axially open groove 59, which enables an axial limit stop 67 to be implemented on axially open groove 59. Within solder depot 75, solder is protected against being unintentionally scraped out by other components.

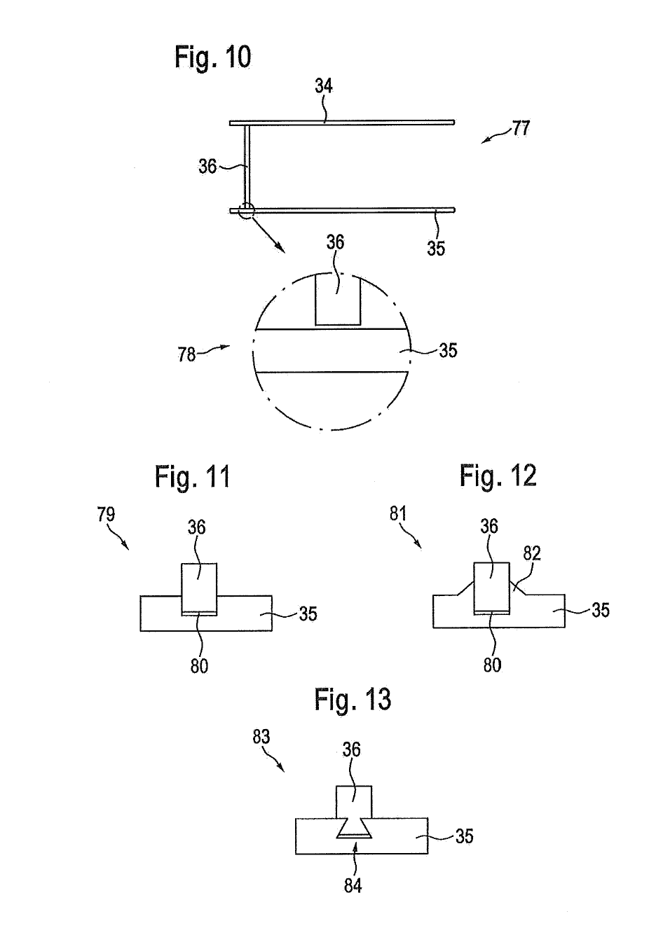

FIGS. 10 through 13 show different options for soldering axial spacer bars 34, 35 to a radial spacer bar 36, thereby making it possible to manufacture a frame 77 of adequate stability.

According to a first option 78, the radial spacer bar 36 is placed flush against axial spacer bar 35 and soldered. However, a positive connection may not be established, giving rise to the danger of an inadequate solder joint.

According to a second option 79 shown in FIG. 11, axial spacer bar 35 has a depression 80, into which radial spacer bar 36 may be inserted and subsequently soldered. This makes it possible to achieve a positive connection.

According to further option 81 illustrated in FIG. 12, an additional raised part 82 is provided around a depression 80, thereby increasing the depth to which radial spacer bar 36 may be inserted into axial spacer bar 35. This connection is therefore able to absorb stronger forces.

According to an alternative option 83, a dovetail connection 84 is provided between radial spacer bar 36 and axial spacer bar 35, thereby achieving a particularly high-quality connection. The handling of spacer bars 35, 36 is also substantially improved thereby prior to cassetting. In particular, this makes it possible to eliminate tack welds.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat exchanger comprising:
a heat exchanger block having an axial inlet opening and an axial outlet opening;
a first axial terminating device;
a second axial terminating device; and
positive fit components for forming a positive fit with the first and second axial terminating devices, the positive fit components projecting at least partially over the axial inlet openings and/or over the axial outlet openings of the heat exchanger block in an axial direction such that the positive fit components are provided radially next to contact shoulders of the axial terminating devices.

2. The heat exchanger according to claim 1, wherein the positive fit components are provided in axially open grooves of the axial terminating devices.

3. The heat exchanger according to claim 1, wherein the positive fit components are formed by radial outer components of the heat exchanger block.

4. The heat exchanger according to claim 3, wherein the radial outer components of the heat exchanger block form a casing of the heat exchanger block.

5. The heat exchanger according to claim 1, wherein the positive fit components are formed by spacer bars and/or by laminated plates of the heat exchanger block.

6. The heat exchanger according to claim 2, wherein the axially open grooves of the axial terminating devices have an outer groove shoulder and/or an inner groove shoulder, on which the positive fit components are supported in a radial direction.

7. The heat exchanger according to claim 1, wherein a radial contact shoulder or an inner groove shoulder of the axially open grooves forms an axial limit stop for components of the heat exchanger block, including laminated plates, spacer bars and/or connecting channels of the heat exchanger block.

8. The heat exchanger according to claim 1, wherein the heat exchanger block has axially acting fixing components that project radially over the heat exchanger block or radially over the casing of the heat exchanger block.

9. The heat exchanger according to claim 1, wherein the axially acting fixing components are provided on the laminated plates and/or on spacer bars.

10. The heat exchanger according to claim 1, wherein the axial terminating devices have radially open fixing grooves for axially acting fixing components of the heat exchanger block.

11. The heat exchanger according to claim 10, wherein the radially open fixing grooves are provided upstream from the axially open grooves in the axial direction.

12. The heat exchanger according to claim 1, wherein an axially open groove of the axial terminating devices and/or a radially open fixing groove of the axial terminating devices has a solder depot.

13. The heat exchanger according to claim 1, wherein the axial terminating devices have a connecting flange for an exhaust gas system of a motor vehicle.

14. The heat exchanger according to claim 1, wherein the heat exchanger block has an exhaust gas side and an evaporator side.

15. The heat exchanger according to claim 1, wherein the heat exchanger is an exhaust gas evaporator of a motor vehicle.
